(19) United States
(12) Patent Application Publication
(10) Pub. No.: US 2013/0328940 A1
(43) Pub. Date: Dec. 12, 2013

(54) DESIGNING DEVICE, DESIGNING METHOD, AND RECORDING MEDIUM

(71) Applicant: FUJITSU LIMITED, Kawasaki-shi (JP)

(72) Inventor: Takaaki YAMAGUCHI, Kawasaki (JP)

(73) Assignee: FUJITSU LIMITED, Kawasaki-shi (JP)

(21) Appl. No.: 13/968,466

(22) Filed: Aug. 16, 2013

Related U.S. Application Data
(63) Continuation of application No. PCT/JP2011/054382, filed on Feb. 25, 2011.

(51) Int. Cl. G09G 5/373

(52) U.S. Cl. CPC G09G 5/373
USPC 345/661

(57) ABSTRACT

A designing device includes a memory and a processor coupled to the memory. The processor executes a process including displaying, selecting, calculating, and causing. The displaying is displaying a designing screen. The selecting is selecting an element serving as a target to be edited from elements displayed on the designing screen. The calculating is calculating a central coordinate and magnification for zoom display of the designing screen based on an execution status of a command when the element is selected at the selecting. The causing is causing a display to perform zoom display of the designing screen at the magnification calculated centering on the central coordinate calculated.

### CROSS-REFERENCE TO RELATED APPLICATION

This application is a continuation of International Application No. PCT/JP2011/054382, filed on Feb. 25, 2011 and designating the U.S., the entire contents of which are incorporated herein by reference.

### FIELD

The embodiment discussed herein is related to a designing device, a designing method, and a designing program.

### BACKGROUND

Conventionally, there have been developed tools that automatically perform an arrangement and wiring operation in designing a large scale integration (LSI) circuit, for example. In the use of such tools, manual modification of the arrangement and wiring thus automatically performed needs to be made to address various problems occurring after the operation, such as erroneous selection and misplacement of an element and to improve the reliability. Specifically, as LSIs have been designed in larger size and with higher performance in recent years, it becomes more important to optimize the arrangement and wiring manually by a designer so as to maximize their performance.

In manual arrangement and wiring performed by the designer, an element is typically quite small with respect to an area on which the arrangement and wiring is performed. For this reason, enlarged display (zoom-in) of the element performed by the designer makes it difficult for him/her to grasp the entire status of the arrangement and wiring. By contrast, when performing equal-length wiring and equal-delay wiring so as to satisfy the timing constraint of such an LSI, the designer needs to adjust the arrangement and wiring appropriately by performing reduced display (zoom-out) for a panoramic view of the entire LSI. This results in a lot of time and troubles in the manual arrangement and wiring performed by the designer.

Several technologies for performing arrangement and wiring in designing a circuit are known, including a technology of a computer aided design (CAD) system for dividing a design drawing to be a target for the arrangement and wiring into a plurality of blocks and performing zoom display of a block selected by the designer on a display. If there are any errors in the arrangement and wiring thus designed in the technology, the designer selects an error desired to be eliminated from an error list and performs zoom display of the portion.
Patent Document 1: Japanese Laid-open Patent Publication No. 07-311785

In the related technology, however, the designer needs to repeat zoom-in for finding a space for wiring on the circuit and zoom-out for checking the direction of the wiring to eliminate the error. This increases the zoom operation performed by the designer, thereby reducing the work efficiency in the arrangement and wiring.

In the arrangement and wiring, the designer needs to perform zoom-in to check the position of a terminal of an element serving as the target. As a result, the target element of the arrangement and wiring is enlarged in the center of a screen. In the subsequent operation, the designer performs zoom-out temporarily for a panoramic view of the entire circuit to determine the position of the wiring, for example, and performs zoom-in again to see a terminal of an element serving as the connecting destination. The designer needs to adjust the position to be zoomed and the magnification for him/herself. This increases time and troubles in the arrangement and wiring operation.

### SUMMARY

According to an aspect of the embodiments, a designing device includes: a memory; and a processor coupled to the memory, wherein the processor executes a process including: displaying a designing screen; selecting an element serving as a target to be edited from elements displayed on the designing screen; calculating a central coordinate and magnification for zoom display of the designing screen based on an execution status of a command when the element is selected at the selecting; and causing a display to perform zoom display of the designing screen at the magnification calculated centering on the central coordinate calculated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view for explaining a circuit designing device according to the present embodiment;

FIG. 2A is an example diagram of a zoom position calculation table;

FIG. 2B is an example diagram of a zoom ratio calculation table;

FIG. 2C is an example diagram of a grid display table;

FIG. 3 is a flowchart of a process performed by the circuit designing device according to the present embodiment;

FIG. 4 is a flowchart for explaining edit target selection processing according to the present embodiment;

FIG. 5 is a flowchart for explaining edit target zoom processing according to the present embodiment;

FIG. 6 is a flowchart for explaining arrangement and wiring edit processing according to the present embodiment;

FIG. 7 is a flowchart for explaining termination processing according to the present embodiment;

FIG. 8 is a flowchart for explaining constraint check processing according to the present embodiment;

FIG. 9 is a flowchart for explaining center-of-gravity-associated display processing according to the present embodiment;

FIG. 10A is a schematic of an edit map window displayed when cells A1 to A5 are selected while a net wiring command is being executed in the center-of-gravity-associated display processing;

FIG. 10B is a schematic of the edit map window displayed when the cell A1 is selected while the net wiring command is being executed in the center-of-gravity-associated display processing;

FIG. 11 is a schematic illustrating a state where wiring is performed from the cell A1 while the net wiring command is being executed in the center-of-gravity-associated display processing;

FIG. 12 is an example diagram of elements serving as a target for an arrangement and wiring operation according to the present embodiment;

FIG. 13 is an example diagram of a user operation, an operation of the circuit designing device, and a designing screen at a phase to start an edit operation according to the present embodiment;

FIG. 14 is an example diagram of a first process of the user operation, the operation of the circuit designing device, and the designing screen at a phase to extract an element to be edited according to the present embodiment;

FIG. 15 is an example diagram of a second process of the user operation, the operation of the circuit designing device, and the designing screen at the phase to extract the element to be edited according to the present embodiment;

FIG. 16 is an example diagram of a third process of the user operation, the operation of the circuit designing device, and the designing screen at the phase to extract the element to be edited according to the present embodiment;

FIG. 17 is an example diagram of the user operation, the operation of the circuit designing device, and the designing screen at a phase to select a command according to the present embodiment;

FIG. 18 is an example diagram of the user operation, the operation of the circuit designing device, and the designing screen at a phase to select the element to be edited according to the present embodiment;

FIG. 19 is an example diagram of the user operation, the operation of the circuit designing device, and the designing screen at a phase to execute a command according to the present embodiment;

FIG. 20 is an example diagram of the user operation, the operation of the circuit designing device, and the designing screen at a phase to check edit results according to the present embodiment;

FIG. 21 is an example diagram of the user operation, the operation of the circuit designing device, and the designing screen at a phase to terminate the edit operation according to the present embodiment; and

FIG. 22 is a diagram of a computer that executes a circuit designing program according to the present embodiment.

### DESCRIPTION OF EMBODIMENTS

Preferred embodiments will be explained with reference to accompanying drawings. The embodiment is not intended to limit the present invention.

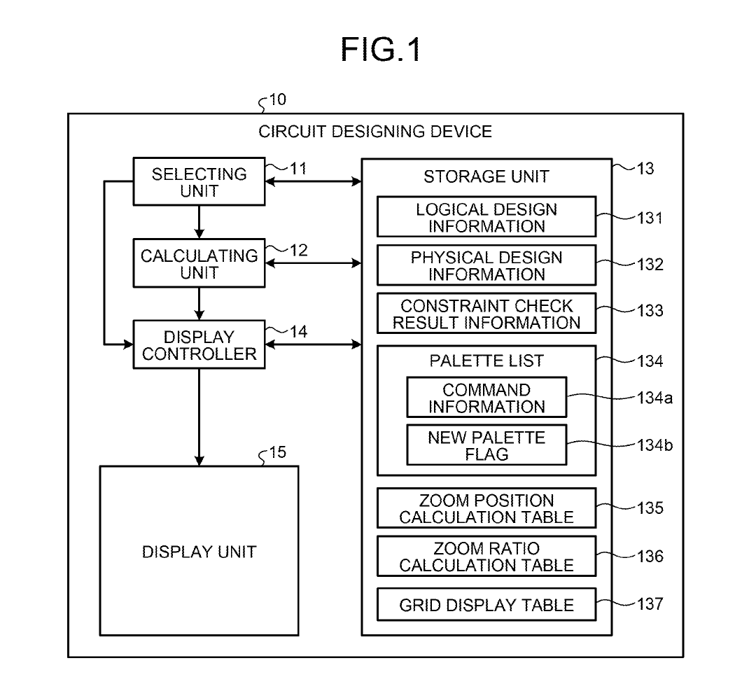

A configuration of a circuit designing device according to an embodiment disclosed in the present application will be described. FIG. 1 is a diagram of a functional configuration of a circuit designing device 10 according to the present embodiment. As illustrated in FIG. 1, the circuit designing device 10 includes a selecting unit 11, a calculating unit 12, a storage unit 13, a display controller 14, and a display unit 15. These components are connected to one another via a bus in a manner capable of transmitting and receiving signals and data unidirectionally or bi-directionally.

In the description below, an element is a concept including a cell and a net. Examples of a cell include a logic element, such as an AND circuit and an OR circuit, and a storage element, such as a flip-flop. A net is a wiring element that connects one or a plurality of cells. A net is further classified into a wire and a via. A wire is a wiring element that connects cells on a single wiring layer (connects cells in a horizontal direction). A via is a wiring element that connects wires, cells, or a wire and a cell between different wiring layers (connects the components in a vertical direction).

The selecting unit 11 selects an element to be edited or a candidate thereof in accordance with an input operation performed by a user, such as a designer, or automatically by using an instruction signal as a trigger. If the user specifies “excess delay error” and “cell unique name A*” and “all the net *” as selection conditions, for example, the selecting unit 11 selects an element that meets the selection conditions as an element to be edited. At this time, one or a plurality of element(s) may be selected. The element selected by the selecting unit 11 is displayed on a palette list window, which will be described later.

The selecting unit 11 further selects a command to be executed in accordance with an instruction input received from the user. Examples of a command to be selected include arrangement of a cell, wiring of a wire, and wiring of a net. The selecting unit 11 also selects an element to be edited from the elements extracted and displayed on the palette list window, which will be described later, in accordance with an input operation performed by the user. Examples of an element to be selected include a cell and a net. At this time, one or a plurality of element(s) may be selected.

Furthermore, the selecting unit 11 selects coordinates at which the element thus selected is to be arranged or wired in accordance with an input operation performed by the user. The selection processing is performed by the user dragging and clicking a mouse, for example.

The selecting unit 11 is physically provided as a central processing unit (CPU), for example.

If an element to be edited is selected, the calculating unit 12 calculates the central coordinates and the magnification for zoom display of a designing screen based on whether the element is a cell or a net. If the selecting unit 11 selects a cell as a target to be edited, for example, the calculating unit 12 determines to perform zoom display centering on the central coordinates of a rectangle circumscribed about the cell such that a side of the rectangle accounts for up to 80% of a side of the designing screen. The calculating unit 12 then instructs the display controller 14 to perform the zoom display. This makes it possible to provide a panoramic view of the arrangement and wiring.

Furthermore, the calculating unit 12 instructs the display controller 14 to perform zoom display correspondingly to an execution status of a command. In other words, the calculating unit 12 calculates the central coordinates and the magnification for zoom display of the designing screen based on the execution status of a command at a point when the element to be edited is selected. If the selecting unit 11 selects a cell as a target to be edited and a cell arrangement command is being executed, for example, the calculating unit 12 instructs the display controller 14 to perform zoom display by a multiple of a grid centering on the lower left coordinates of the cell thus selected. This facilitates an arrangement operation of the cell.

If a plurality of elements are selected, the calculating unit 12 performs processing similar to that described above. In other words, the calculating unit 12 calculates the central coordinates of a rectangle circumscribed about the elements thus selected and calculates the magnification that makes a side of the rectangle circumscribed about the elements 80% of a side of the designing screen. The calculating unit 12 then outputs the calculation results to the display controller 14 and instructs the display controller 14 to perform zoom display with the central coordinates and the magnification. This makes it possible to provide a panoramic view of the arrangement and wiring. The calculating unit 12 is physically provided as the CPU, for example.

The storage unit 13 stores therein information displayed on the display unit 15, which will be described later, in an updatable manner. The storage unit 13 stores therein information used for displaying various types of windows constituting the designing screen. Specifically, the storage unit 13 stores therein logical design information 131 as information used for displaying a net list window and physical design information 132 as information used for displaying an edit map window. The storage unit 13 further stores therein constraint check result information 133 as information used for displaying an error result window and palette list 134 as information used for displaying a palette list window. The palette list 134 includes history information of elements previously selected as a target to be edited or a candidate thereof. This makes it possible to reuse the palette list 134.

The logical design information is information indicating what types of cells and nets are included in a logic circuit serving as a target for arrangement and wiring (information related to the types and the attributes of the elements themselves). The physical design information is information related to arrangement and wiring of the elements, such as the positions at which the cells are to be arranged and the types of wiring to be performed. The constraint check result information is error information indicating a portion at which a constraint on arrangement and wiring is violated and the type thereof.

The palette list 134 stores therein command information 134a and a new palette flag 134b. The command information 134a indicates an execution status of a command, such as any one of “arrangement of a cell is being performed”, “wiring of a wire is being performed”, “wiring of a net is being performed”, and “yet to be executed”. The new palette flag 134b indicates whether to newly add information of the palette list 134 as history information or to overwrite and update the information. If the new palette flag 134b is turned ON, the information of the palette list 134 is added. By contrast, if the new palette flag 134b is turned OFF, the information is overwritten and updated.

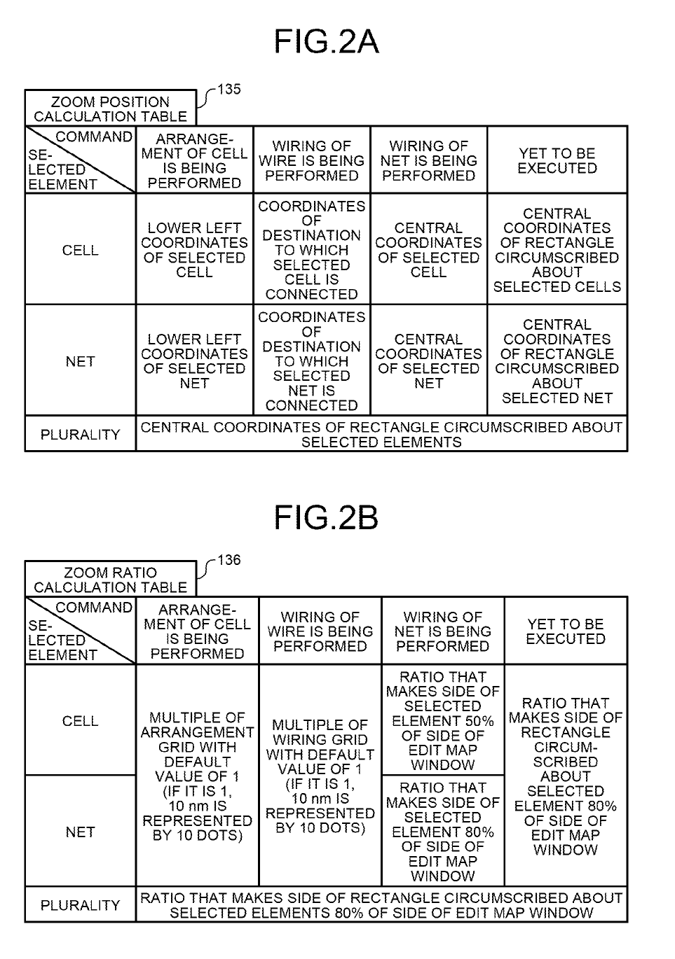

The storage unit 13 includes various types of tables referred to when the calculating unit 12 determines the central coordinates and the magnification for zoom. FIG. 2A is an example diagram of a table referred to in calculation of a zoom position. As illustrated in FIG. 2A, a zoom position calculation table 135 stores therein the central coordinates for zoom in a manner associated with selected elements and the command information 134a. The command information 134a is assigned with “arrangement of a cell is being performed”, “wiring of a wire is being performed”, “wiring of a net is being performed”, and “yet to be executed”. The selected elements are assigned with “cell”, “net”, and “plurality”. With respect to the selected element of “cell”, the zoom position calculation table 135 stores therein “coordinates of the lower-left end of the selected cell”, “coordinates of a destination to which the selected cell is connected”, “central coordinates of the selected cell”, and “central coordinates of a rectangle circumscribed about the selected cell” in a manner associated with the respective execution statuses of the command. Similarly, with respect to the selected element of “net”, the zoom position calculation table 135 stores therein “coordinates of the lower-left end of the selected net”, “coordinates of a destination to which the selected net is connected”, “central coordinates of the selected net”, and “central coordinates of a rectangle circumscribed about the selected net” in a manner associated with the respective execution statuses of the command. With respect to the selected element of “plurality”, the zoom position calculation table 135 stores therein “central coordinates of a rectangle circumscribed about the selected elements” regardless of the execution status of the command. As a result, if the command is “wiring of a net is being performed” and “cell” is selected as the element, for example, the central coordinates of the selected cell is calculated as the zoom position.

FIG. 2B is an example diagram of a table referred to in calculation of a zoom ratio. As illustrated in FIG. 2B, a zoom ratio calculation table 136 stores therein the magnification of zoom in a manner associated with selected elements and the command information 134a. The command information 134a is assigned with “arrangement of a cell is being performed”, “wiring of a wire is being performed”, “wiring of a net is being performed”, and “yet to be executed”. The selected elements are assigned with “cell”, “net”, and “plurality”. With respect to the selected element of “cell”, the zoom ratio calculation table 136 stores therein “multiple of an arrangement grid (default value is 1)” and “multiple of a wiring grid (default value is 1)” in a manner associated with the execution statuses of the command. Furthermore, the zoom ratio calculation table 136 stores therein “ratio that makes a side of the selected element 50% of a side of the edit map window” and “ratio that makes a side of a rectangle circumscribed about the selected element 80% of a side of the edit map window” in a manner associated with the execution statuses of the command. The multiple of the arrangement grid may be set as follows: if the multiple is 1, 10 nm is represented by 10 dots; whereas if the multiple is 2, 10 nm is represented by 20 dots, for example. Similarly, with respect to the selected element of “net”, the zoom ratio calculation table 136 stores therein “multiple of an arrangement grid (default value is 1)” and “multiple of a wiring grid (default value is 1)” in a manner associated with the execution statuses of the command. Furthermore, the zoom ratio calculation table 136 stores therein “ratio that makes a side of the selected element 50% of a side of the edit map window” and “ratio that makes a side of a rectangle circumscribed about the selected element 80% of a side of the edit map window” in a manner associated with the execution statuses of the command. With respect to the selected element of “plurality”, the zoom ratio calculation table 136 stores therein “ratio that makes a side of a rectangle circumscribed about the selected elements 80% of a side of the edit map window” regardless of the execution status of the command. As a result, if the command is “arrangement of a cell is being performed” and a “plurality” of elements are selected, for example, magnification that makes a side of a rectangle circumscribed about the elements 80% of a side of the edit map window is calculated as the zoom ratio.

FIG. 2C is an example diagram of a table referred to in determination of whether to perform grid display. As illustrated in FIG. 2C, a grid display table 137 stores therein display or non-display of a grid in a manner associated with selected elements and the command information 134a. The command information 134a is assigned with “arrangement of a cell is being performed”, “wiring of a wire is being performed”, “wiring of a net is being performed”, and “yet to be executed”. The selected elements include “cell”, “net”, and “plurality”. The grid display table 137 stores therein “display of an arrangement grid”, “display of a wiring grid”, “non-display”, and “non-display” in a manner associated with the respective execution statuses of the command. While the same grid display is set regardless of the selected element in the present embodiment, display or non-display of the grid and the aspect thereof may differ depending on the selected element.

The storage unit 13 is physically provided as a storage device, such as a hard disk.

The display controller 14 performs zoom processing of the designing screen in accordance with the central coordinates and the magnification received from the calculating unit 12. Specifically, the display controller 14 displays, on the palette list window, elements serving as candidates of a target to be edited selected by the selecting unit 11 from all the elements on the designing screen. The elements displayed on the palette list window are narrowed down every time the user specifies a selection condition. The display controller 14 displays the palette list window while updating the palette list window every time the elements are narrowed down.

In addition, the display controller 14 displays the edit map window. The display controller 14 updates the edit map window as needed such that the elements on the palate list at each time point can be identified on the designing screen. Examples of the way for displaying the elements serving as candidates of a target to be edited in an identifiable manner can include a thick line frame, shading, and coloring.

If an element to be edited is actually specified from the candidates, the display controller 14 updates display of the palette list window such that the element can be identified. At the same time, the display controller 14 updates display of the edit map window similarly. If a plurality of elements are selected as elements to be edited, the elements are displayed in an identifiable manner. The palette list window (text display) can display the elements to be edited in a manner identified with bold letters, an underline, shading, and a border, for example. The edit map window (graphic display) can display the elements with a thick line, a thick line frame, shading, and coloring, for example.

The display controller 14 is physically provided as the CPU, for example.

The display unit 15 displays the designing screen and actually performs zoom display of the designing screen in accordance with an instruction input received from the display controller 14.

The display unit 15 is physically provided as an liquid crystal display, for example.

The following describes an operation of the circuit designing device 10.

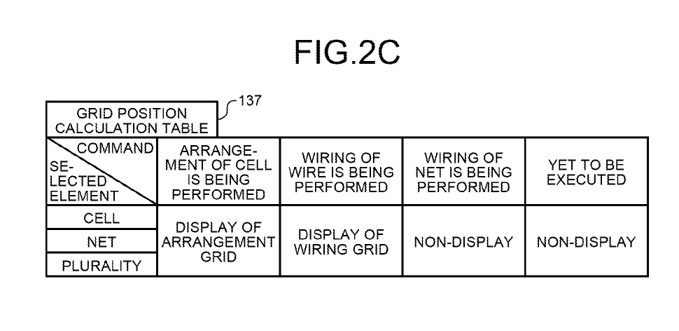

A series of processing performed by the circuit designing device 10 will be described with reference to FIG. 3. FIG. 3 is a flowchart of a process performed by the circuit designing device according to the present embodiment. The circuit designing device 10 waits for an instruction to perform edit target selection processing or constraint check processing, which will be described later. If an instruction is received (Yes at Step S1), the circuit designing device 10 determines whether the instruction is an instruction for constraint check (Step S2).

If the instruction is not an instruction for constraint check at Step S2 (No at Step S2), the circuit designing device 10 performs edit target selection processing (Step S3) and edit target zoom processing (Step S4), which will be described later. Subsequently, the circuit designing device 10 performs arrangement and wiring edit processing (Step S5) and termination processing (Step S6), which will be described later. By contrast, if the instruction is an instruction for constraint check (Yes at Step S2), the circuit designing device 10 performs the constraint check processing, which will be described later (Step S7).

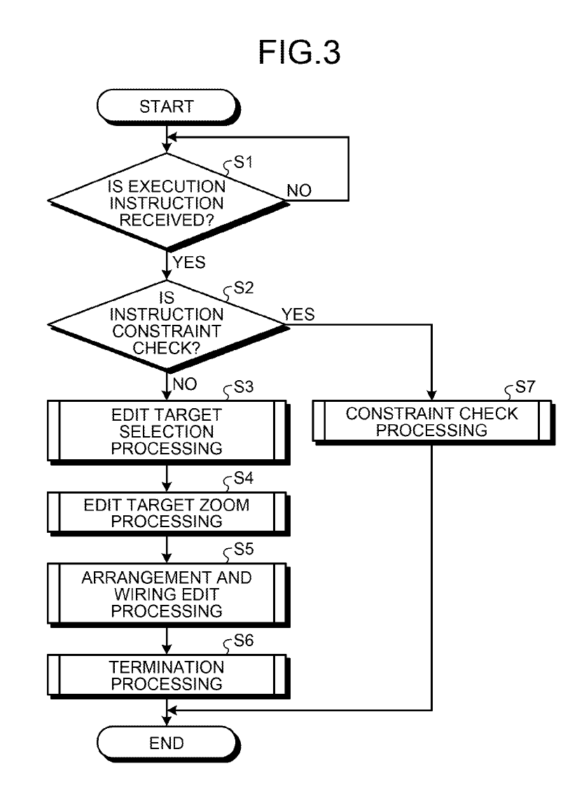

The edit target selection processing will now be described with reference to the flowchart of FIG. 4.

The circuit designing device 10 causes the selecting unit 11 to wait for input of a command (Step S301). If a command is received (Yes at Step S301), the circuit designing device 10 stores the type of the command in the palette list 134 as the command information 134a (Step S302). The command information 134a is referred to when the palette list 134 is displayed as an index used to select elements listed thereon.

If selection conditions related to logical design information are received from the net list window at Step S303 (Yes at Step S303), the circuit designing device 10 reads the logical design information 131 from the storage unit 13. The circuit designing device 10 then generates a list of the logical design information 131 that meets the selection conditions (Step S304). At the same time, “net” is set as the type of the list. Subsequently, processing at Step S311 is performed, which will be described later.

The selection conditions input by the net list window can be specified based on the unique name of an element (a cell or a net), the type of an element, the name of a connected net, and a critical path, for example.

If selection conditions related to physical design information are received from the edit map window at Step S305 (Yes at Step S305), the circuit designing device 10 reads the physical design information 132 from the storage unit 13. The circuit designing device 10 then generates a list of the physical design information 132 that meets the selection conditions (Step S306). At the same time, “figure” is set as the type of the list. Subsequently, processing at Step S311 is performed, which will be described later.

The selection conditions input by the edit map window can be specified based on point coordinates and a rectangular area specified on the map and by wiring level, for example.

If selection conditions related to constraint check result information are received from the error result window at Step S307 (Yes at Step S307), the circuit designing device 10 reads the constraint check result information 133 from the storage unit 13. The circuit designing device 10 then generates a list of the constraint check result information 133 that meets the selection conditions (Step S308). At the same time, “constraint” is set as the type of the list. Subsequently, processing at Step S311 is performed, which will be described later.

The selection conditions input by the error result window can be specified based on an arrangement error, a wiring error, a delay error, and a design rule error, for example.

Subsequently, the circuit designing device 10 determines whether the palette list 134 is present in the storage unit 13 at Step S309. If the palette list 134 is present (Yes at Step S309), the circuit designing device 10 acquires history information of the palette list 134 from the storage unit 13 to generate an item list from the information (Step S310). At the same time, “palette” is set as the type of the list. Subsequently, processing at Step S311 is performed, which will be described later.

The circuit designing device 10 then determines whether the type of the list being set at this point is “palette” (Step S311). If the type of the list is “palette” (Yes at Step S311), the circuit designing device 10 narrows down the elements based on various types of information of the logical design information 131, the physical design information 132, and the constraint check result information 133. This operation generates the palette list 134. After the generation, the new palette flag 134b is set to “ON” (Step S312).

If the type of the list is not palette at Step S311 (No at Step S311), the circuit designing device 10 determines whether the type of the list is identical (Step S313). Subsequently, processing similar to that at Step S312 is performed. Specifically, the circuit designing device 10 adds various types of information of the logical design information 131, the physical design information 132, and the constraint check result information 133 to generate the palette list 134. After the generation, the new palette flag 134b is set to “ON” (Step S314).

The palette list 134 generated at Step S312 and Step S314 is displayed on the palette list window as a list of targets for arrangement and wiring (Step S315).

An assumption is made that the user selects a cell of “A*” from the net list window at Step S303 and collectively selects a rectangular area not including cells A6 and A7 from the edit map window by dragging the mouse, for example. In this case, cells A1 to A5 included in the rectangular area are listed at Step S312. Thus, the cells A1 to A5 are displayed on the palette list window at Step S315.

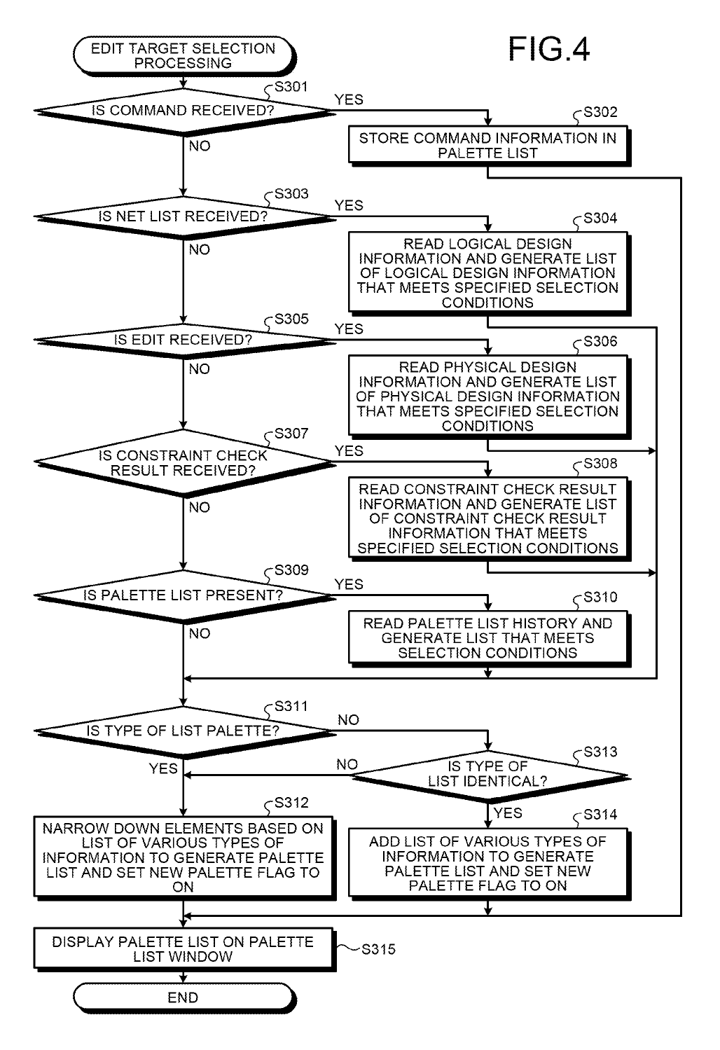

The edit target zoom processing will now be described with reference to the flowchart of FIG. 5.

In selected element determination processing at Step S401, it is determined whether a plurality of elements are selected. If it is determined that one element is selected as a result of the determination (No at Step S401), the edit target zoom processing is shifted to command determination processing. In the command determination processing, the circuit designing device 10 causes the calculating unit 12 to determine the status of a command at this point. Specifically, the calculating unit 12 determines whether the execution status of the command is “arrangement of a cell”, “wiring of a wire”, or “wiring of a net”, or corresponds to none of these statuses (Steps S402 to S404).

If the execution status of the command corresponds to none of these statuses (No at Step S404), the calculating unit 12 determines that the command is “yet to be executed” and that the selected element is “all the elements” (Step S405).

If the command is “wiring of a net” at Step S404 (Yes at Step S404), the calculating unit 12 determines whether the selected element is a “cell” (Step S406). If it is determined that the selected elements is not a “cell” as a result of the determination (No at Step S406), the calculating unit 12 determines that the command is “wiring of a net” and that the selected element is a “net” (Step S407). By contrast, if it is determined that the selected elements is a cell (Yes at Step S406), the calculating unit 12 determines that the command is “wiring of a net” and that the selected element is a “cell” (Step S408).

If it is determined that a plurality of elements are selected as a result of the determination at Step S401 (Yes at Step S401), processing at Step S409 is performed. Specifically, the calculating unit 12 determines that the command is “all the commands” and that the selected element is present in “plurality” (Step S409).

If it is determined that one element is selected (No at Step S401) and the execution status of the command is “arrangement of a cell” (Yes at Step S402), the calculating unit 12 determines that the command is “arrangement of a cell” and that the selected element is “all the elements” (Step S410). Similarly, if the execution status of the command is “wiring of a wire” (Yes at Step S403), the calculating unit 12 determines that the command is “wiring of a wire” and that the selected element is “all the elements” (Step S411).

After the determination result is derived, zoom setting calculation processing at Step S412 is performed. In the processing, the calculating unit 12 refers to the zoom position calculation table 135 and the zoom ratio calculation table 136 to set the center position and the magnification for zoom display of the edit map window based on the determination results (Step S412).

At subsequent Steps S413 to S417, display or non-display of a grid is determined. Specifically, the circuit designing device 10 causes the calculating unit 12 to determine whether the execution status of the command is “arrangement of a cell” (Step S413). If it is determined that the command is “arrangement of a cell” as a result of the determination (Yes at Step S413), the circuit designing device 10 causes the display controller 14 to display an arrangement grid for the edit map window on which zoom display is performed (Step S414). If the command is “wiring of a wire” (Yes at Step S415), the circuit designing device 10 displays a wiring grid for the edit map window on which zoom display is performed (Step S416). If the command is neither “arrangement of a cell” nor “wiring of a wire” (No at Step S415), the circuit designing device 10 displays no grid (Step S417).

At Step S418, the circuit designing device 10 performs zoom display of the physical design information 132 on the edit map window of the display unit 15 based on the coordinates of the center position and the magnification for zoom set at Step S412 (Step S418).

At this time, the zoom position and the zoom ratio of the edit map window on which zoom display is performed can be changed as needed by an input operation performed by the user.

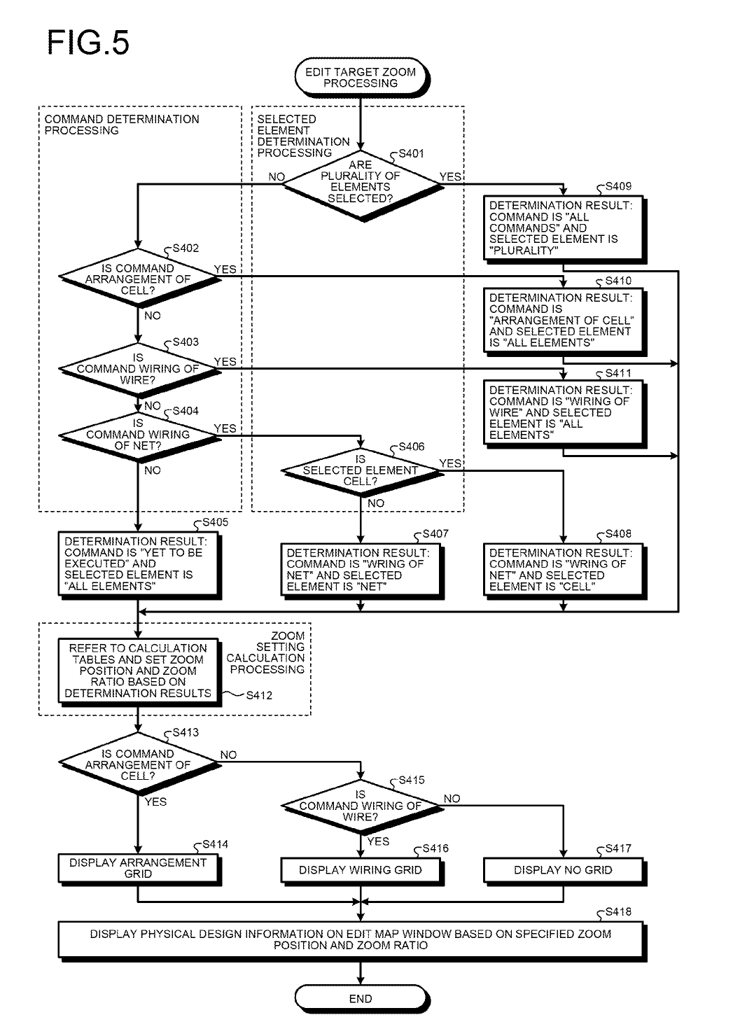

The arrangement and wiring edit processing will now be described with reference to FIG. 6. FIG. 6 is a flowchart for explaining the arrangement and wiring edit processing according to the present embodiment.

The circuit designing device 10 determines whether the command is arrangement of a cell (Step S501). If the command is edit processing for arrangement of a cell (Yes at Step S501), the circuit designing device 10 causes the calculating unit 12 to calculate the position coordinates of the center of gravity among cells (Step S503). Specifically, the calculating unit 12 derives the coordinate positions of all the cells connected to the cell selected in the edit target selection processing via a net, thereby calculating the coordinates of the position of the center of gravity of all the cells as the center of gravity among cells. Subsequently, the display controller 14 displays a rubber band for displaying the center of gravity based on the position coordinates of the center of gravity among cells calculated at Step S503 (Step S504). The rubber band is displayed radially on the edit map window so as to connect the center of gravity among cells and terminals of the respective cells, for example. The rubber band serves as an index of a wiring direction when the user performs wiring from the selected cell toward the direction of the center of gravity of all the cells. All the cells in the direction of the center of gravity of all the cells mean all the selected cells and all the cells connected to the net thus selected.

If it is determined that the command is wiring of a net (Yes at Step S502), the circuit designing device 10 performs processing similar to those at Steps S503 and S504.

If the processing at Step S504 is finished or if it is determined that the target to be edited is not wiring of a net at Step S502 (No at Step S502), the arrangement and wiring edit processing as described above is terminated.

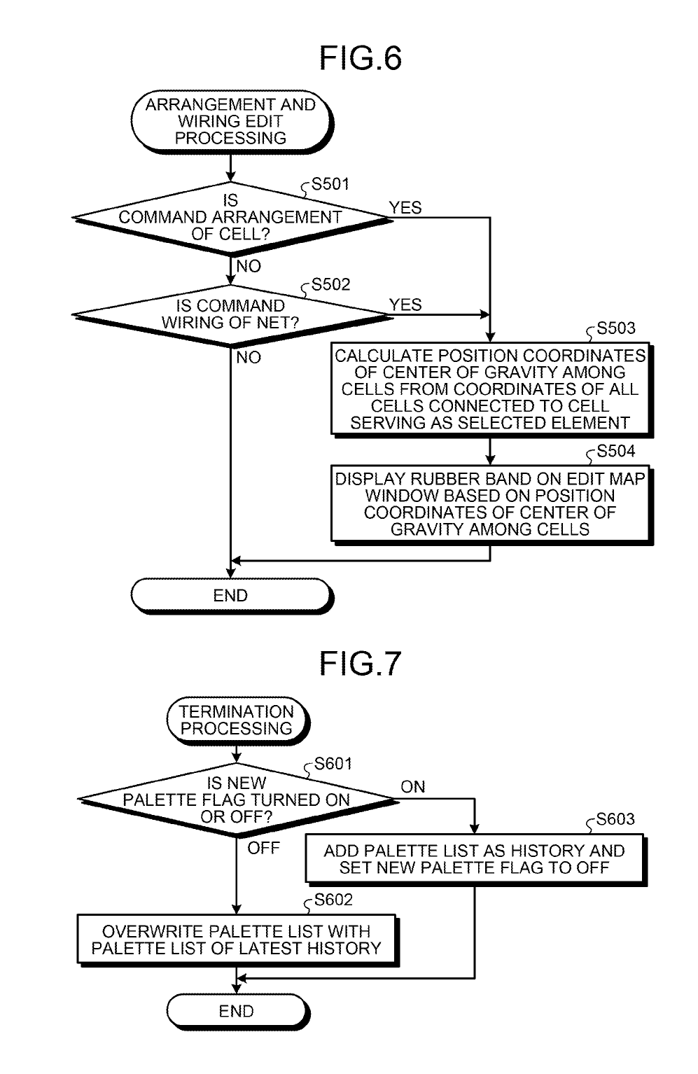

The termination processing will now be described with reference to FIG. 7. FIG. 7 is a flowchart for explaining the termination processing according to the present embodiment.

In the termination processing, the circuit designing device 10 determines whether the new palette flag 134b of the palette list 134 is turned “ON” or “OFF” (Step S601). If it is determined that the new palette flag 134b is turned “OFF” as a result of the determination (OFF at Step S601), the circuit designing device 10 overwrites information of the palette list 134 with the palette list of the latest history (S602). Thus, the palette list 134 is updated (overwritten and saved) with the latest palette list.

By contrast, if it is determined that the new palette flag 134b is turned “ON” as a result of the determination at Step S601 (ON at Step S601), the circuit designing device 10 adds a palette list as a history. The circuit designing device 10 then changes the setting of the new palette flag 134b from “ON” to “OFF” (Step S603). Thus, the latest palette list is added (saved under a different name) as the history information in the palette list 134 of the storage unit 13.

The history information of the palette list may be deleted in chronological order or ascending order of frequency of usage if the data capacity exceeds a particular value. Furthermore, the user may delete unnecessary history information from the palette list 134. Furthermore, history information to be reused is prevented from being deleted by assigning a name or a symbol thereto. This facilitates the reuse of the history information.

The history information of the palette list facilitates reuse (recycle) of a palette list previously used by the user. In addition, providing new selection conditions to the previous history information enables the user to narrow down desired elements.

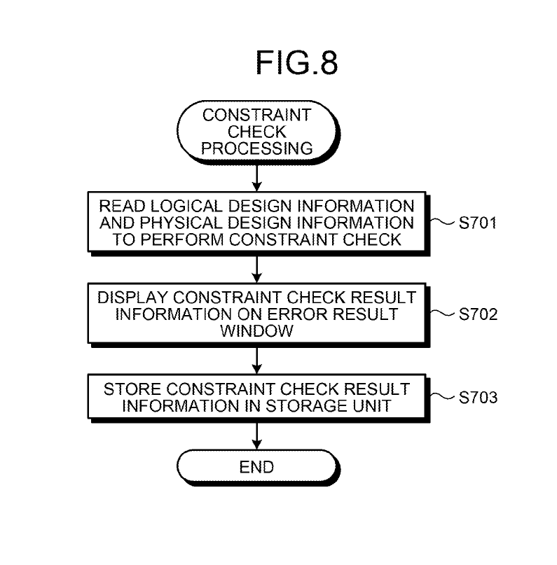

The constraint check processing will now be described with reference to FIG. 8. FIG. 8 is a flowchart for explaining the constraint check processing according to the present embodiment.

The circuit designing device 10 causes the calculating unit 12 to acquire the logical design information 131 and the physical design information 132 from the storage unit 13. The circuit designing device 10 then refers to the physical design information 132 to perform a check (a constraint check) of whether an error is present in the arrangement and wiring (Step S701). The constraint check includes an arrangement check, a wiring check, a timing check, and a design rule check, for example.

The results of the constraint check are displayed on the error result window by the display controller 14 (Step S702). Furthermore, the results of the constraint check are stored in the storage unit 13 as the constraint check result information 133 (Step S703). Subsequently, the constraint check processing is terminated.

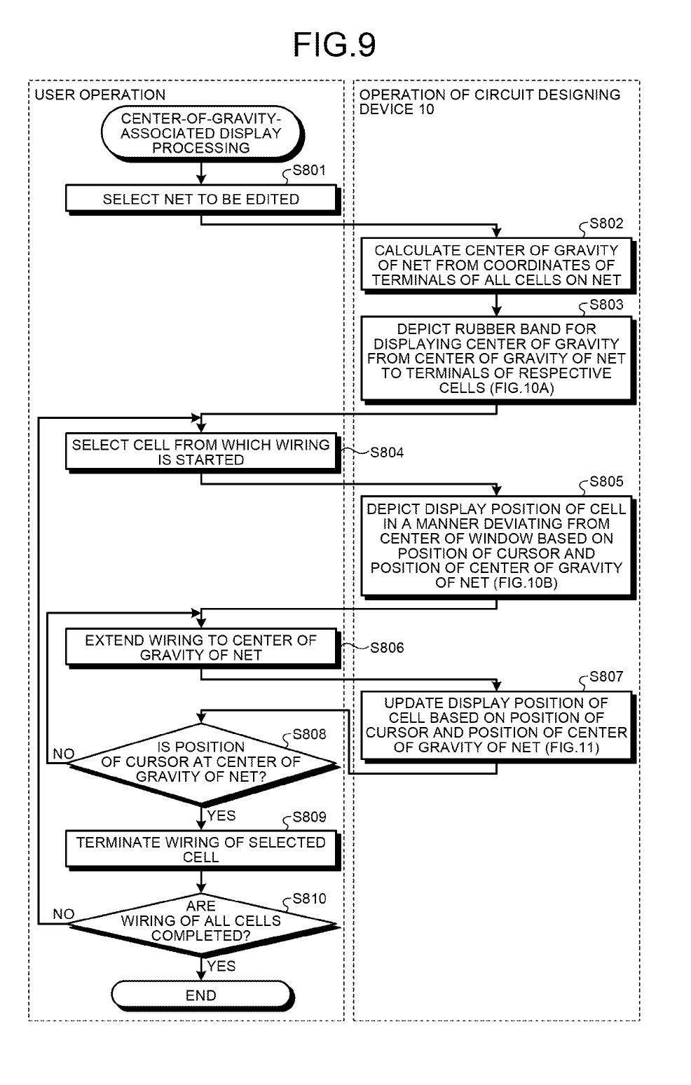

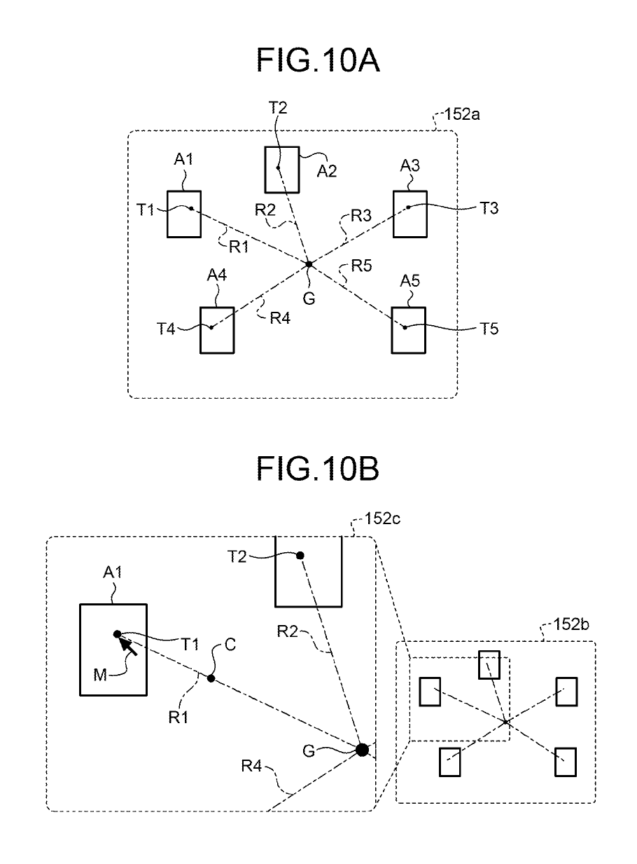

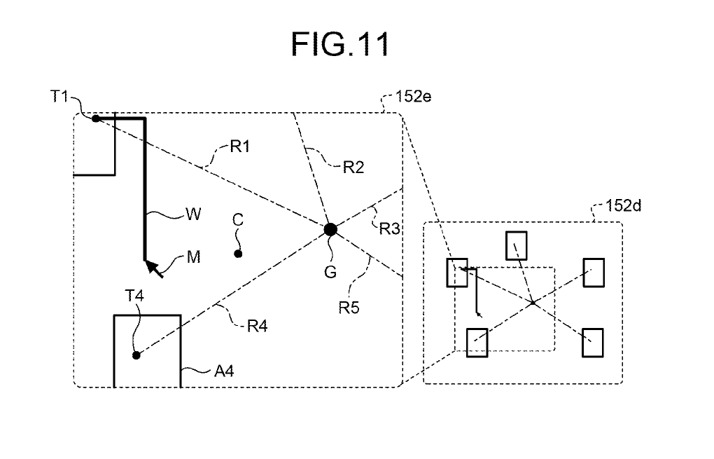

Processing of a phase on which the user actually performs a wiring operation of an yet-to-be-wired net will now be described with reference to FIG. 9, FIG. 10A, FIG. 10B, and FIG. 11.

FIG. 9 is a flowchart for explaining center-of-gravity-associated display processing according to the present embodiment.

If the user selects a net to be edited from the palette list window (Step S801), the calculating unit 12 calculates coordinates G of the position of the center of gravity among cells from the coordinates of the respective terminals of all the cells on the net (Step S802).

At this time, one element, consecutive elements, a plurality of elements, or a subsequent item on the previous palette list, for example, may be selected as the element from the palette list window.

If the coordinates G of the position of the center of gravity calculated by the calculating unit 12 is received, the display controller 14 depicts the rubber band for displaying the center of gravity from the coordinates G to the terminals of the respective cells on the net (Step S803). FIG. 10A is an example schematic of an edit map window 152a on which rubber bands R1 to R5 are depicted when the cells A1 to A5 are present on the net.

If the user selects a cell from which wiring is started from the palette list window (Step S804), the display controller 14 moves a mouse cursor to the coordinates of the terminal of the cell. The display controller 14 then displays the cell such that the display position of the cell thus selected deviates from the center position of the screen based on the position of the mouse cursor and the position of the center of gravity (Step S805). Specifically, the display controller 14 performs zoom display such that the midpoint between the coordinates of the mouse cursor located at the position of the terminal of the cell thus selected and the coordinates of the position of the center of gravity among cells is positioned at the center of the edit map window. FIG. 10B is an example schematic of an edit map window 152c displayed when the cell A1 is selected.

In FIG. 10B, an edit map window 152b is zoomed to be the edit map window 152c. Because the cell A1 is selected as the start point of the wiring in the edit map window 152c, a mouse cursor M is positioned on a terminal T1 of the cell A1. The middle point between the mouse cursor M and the position of the center of gravity G (midpoint of the rubber band R1 for displaying the center of gravity) corresponds to central coordinates C of the edit map window 152c. As a result, the cell A1 is displayed in a manner deviating to the upper left end of the screen. In other words, the cell A1 serving as the target for wiring is displayed in a manner deviating in a direction (e.g., an upper-left direction) opposite to a direction to draw a wire on the screen.

The processing at Step S805 enlarges the area in the direction from the cell serving as the origin of the wiring to the center of gravity on the edit map window. In FIG. 10B, for example, the area near the center point C in the direction from the cell A1 to the center of gravity G among cells is displayed in an enlarged manner. This makes wiring in the lower-right direction easier, thereby facilitating the user's wiring in the direction. In addition, the user can readily grasp the positional relation between the cell A1 and other cells from the positional relation between the rubber band R1 for displaying the center of gravity and the central coordinates C without performing zoom-out for the panoramic view of the positional relation among all the cells A1 to A5.

If the user extends the wiring in the direction toward the center of gravity among cells by a mouse operation at Step S806, the display controller 14 updates the display position of the cell based on the position of the mouse cursor and the position of the center of gravity (Step S807). Specifically, the display controller 14 updates zoom display such that the center of the edit map window is positioned on a line connecting the coordinates of the mouse cursor being positioned at the tip of the wiring and the position coordinates of the center of gravity among cells. FIG. 11 is an example schematic of an edit map window 152e displayed when wiring from the cell A1 to the lower right side of the screen is started.

In FIG. 11, an edit map window 152d is zoomed to be the edit map window 152e. The edit map window 152e depicts a wire W starting from the terminal T1 of the cell A1 and ending at the position coordinates of the mouse cursor M. Movement of the mouse cursor M causes the center of the edit map window to move onto the line connecting the mouse cursor M and the position of the center of gravity G among cells. In association with the movement, zoom display is performed centering on the central coordinates C of the edit map window 152e.

In terms of the positional relation among the mouse cursor M, the center point C of the screen, and the position of the center of gravity G, the center point C of the screen is constantly positioned on the line passing through the mouse cursor M and the position of the center of gravity G. The distance between M and C has a particular relation with the distance between C and G as described above. The particular relation includes the case where the distance between M and C is equal to (the same distance as) the distance between C and G and the case where the distance between M and C has a proportional relation with the distance between C and G. Thus, movement of the mouse cursor M to the position of the center of gravity G causes the mouse cursor M to coincide with the center point C of the screen, for example. By contrast, movement of the mouse cursor M in a direction away from the position of the center of gravity G causes the position of the center of gravity G to eventually disappear from the window. This enables the user to notice that the mouse cursor M is moving in a direction opposite to the center of gravity. At this time, the position of the center of gravity G is placed on the opposite side of the moving direction of the mouse cursor M. If the user is moving the mouse cursor M in a lower-left direction, the center of gravity is placed at a position in an upper-right direction outside the screen. Thus, drawing the wire in the upper-right direction enables the user to achieve wiring toward the center of gravity.

The mouse cursor M is constantly displayed on the edit map window. Even if the position of the center of gravity G moves outside the window, the distance between M and C maintains the proportional relation with the distance between C and G. In other words, the user can grasp a change in the distance between the center point C of the screen and the position of the center of gravity G based on a change in the distance between the mouse cursor M and the center point C of the screen. Thus, the user can readily and promptly grasp the progress of the wiring based on the change.

The processing at Step S807 enlarges the area in the direction from the tip of the wire to the center of gravity in the edit map window. In FIG. 11, for example, the area near the center point C in the direction from the tip M of the wire W to the center of gravity G is displayed in an enlarged manner. This makes wiring in the upper-right direction easier, thereby facilitating the user's wiring in the direction. In addition, the user can readily grasp the positional relation between the wire W and the cells A1 to A5 from the positional relation between the rubber bands R1 and R4 for displaying the center of gravity and the central coordinates C without performing zoom-out for the panoramic view of the positional relation among all the cells A1 to A5 again.

The processing at Steps S806 and S807 is repeatedly performed until the position of the mouse cursor reaches the position of the center of gravity among cells (Step S808). If the mouse cursor reaches the position of the center of gravity (Yes at Step S808), the wiring related to the cell selected at Step S804 is terminated (Step S809).

The system control goes to Step S810, and the series of processing from Step S804 to Step S809 is performed on all the cells on the net to be edited. In other words, if an yet-to-be-wired cell remains when the wiring at Step S809 is finished (No at Step S810), the system control is returned to Step S804, and the yet-to-be-wired cell is selected as a cell from which wiring is started. Subsequently, the processing is repeated from Step S804. As a result, if the wiring for all the cells on the net is completed (Yes at Step S810), the wiring operation for the yet-to-be-wired net using the center-of-gravity-associated display processing is terminated.

The explanation of the operation with reference to the flowcharts is completed.

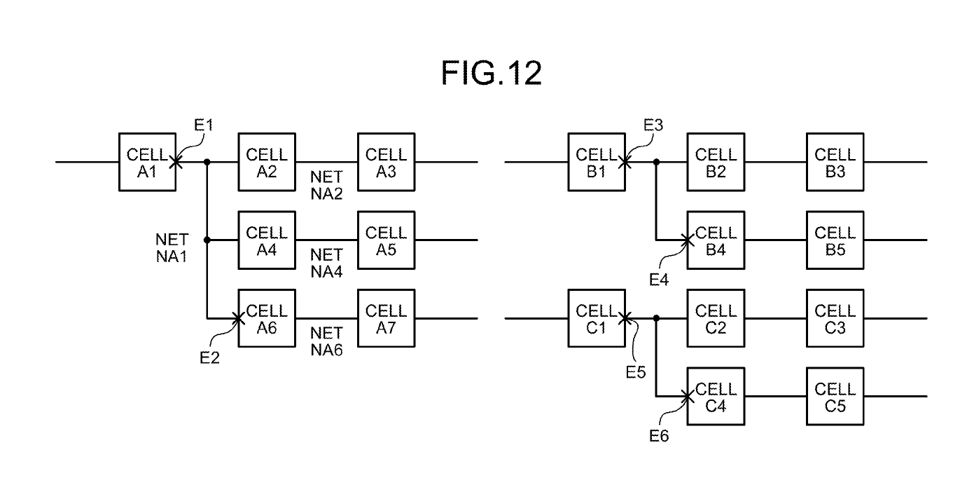

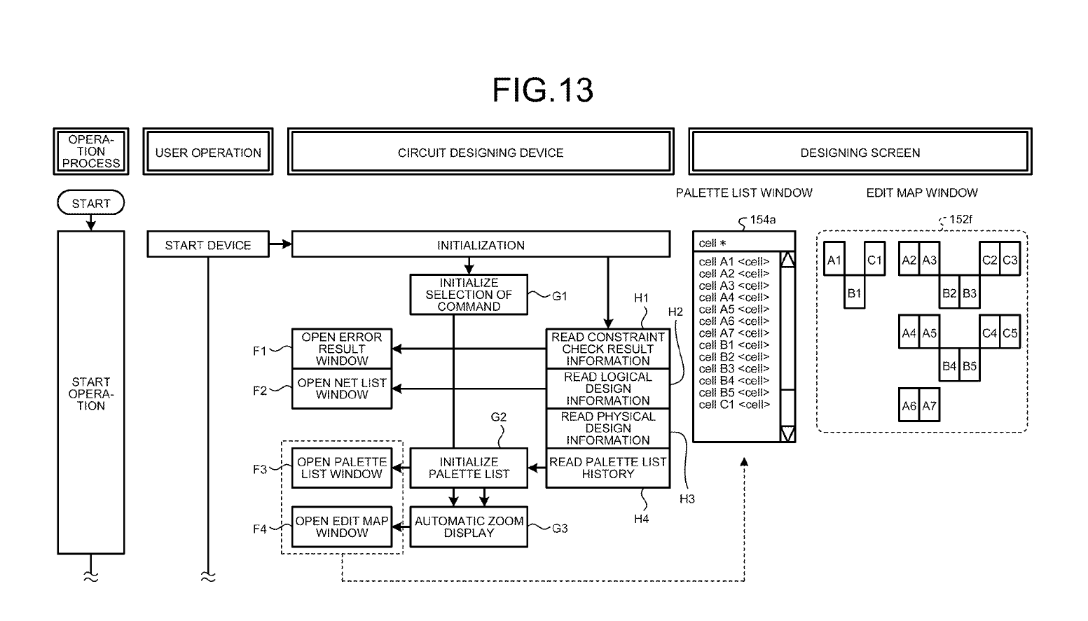

The transition of the palette list window and the edit map window along with the series of processing described above will now be described with reference to FIG. 13 to FIG. 21 using a logic circuit in the arrangement and wiring state illustrated in FIG. 12 as an example.

FIG. 12 is an example diagram of elements serving as a target for an arrangement and wiring operation according to the present embodiment. In the present embodiment, the circuit serving as a target for the arrangement and wiring operation is arranged and wired based on the logical design information 131 and the physical design information 132 in advance but has errors found in a subsequent design rule check. As illustrated in FIG. 12, the logic circuit to be edited includes at least cells A1 to A7, cells B1 to B5, cells C1 to C5, and nets NA1, NA2, NA4, and NA6. The logic circuit to be edited further has six errors E1 to E6 as the constraint check result information 133. Crosses in FIG. 12 represent error portions.

The following describes processing for modifying the error E1 performed by the user with the circuit designing device 10 along an actual operation process using a process for modifying the error E1 present in the cell A1 as an example.

FIG. 13 is an example diagram of the user operation, the operation of the circuit designing device 10, and the designing screen at a phase to start an edit operation according to the present embodiment. As illustrated in FIG. 13, if the user starts the circuit designing device 10, selection of a command is initialized, whereby there is no command being selected (G1). If the user opens the error result window (F1), the constraint check result information 133 is read from the storage unit 13 (H1) and is displayed on the error result window. Similarly, if the user opens the net list window (F2), the logical design information 131 is read from the storage unit 13 (H2) and is displayed on the net list window. If the user opens the palette list window (F3), the palette list history is read from the storage unit 13 (H4), and a palette list on which all the elements are selected is displayed on the palette list window as the initial state (G2). Because all the cells are selected at the start of the device, the designing screen of the display unit 15 displays all the cells A1 to A7, B1 to B5, and C1 to C5 with a scroll bar as indicated by a palette list window 154a. Similarly, the physical design information 132 is read from the storage unit 13 (H3) and is displayed on the edit map window (F4). At this time, automatic zoom display is performed (G3). Because the command is set to “yet to be selected” and the selected element is set to “plurality” as the initial value, the display state of the designing screen is like that of an edit map window 152f.

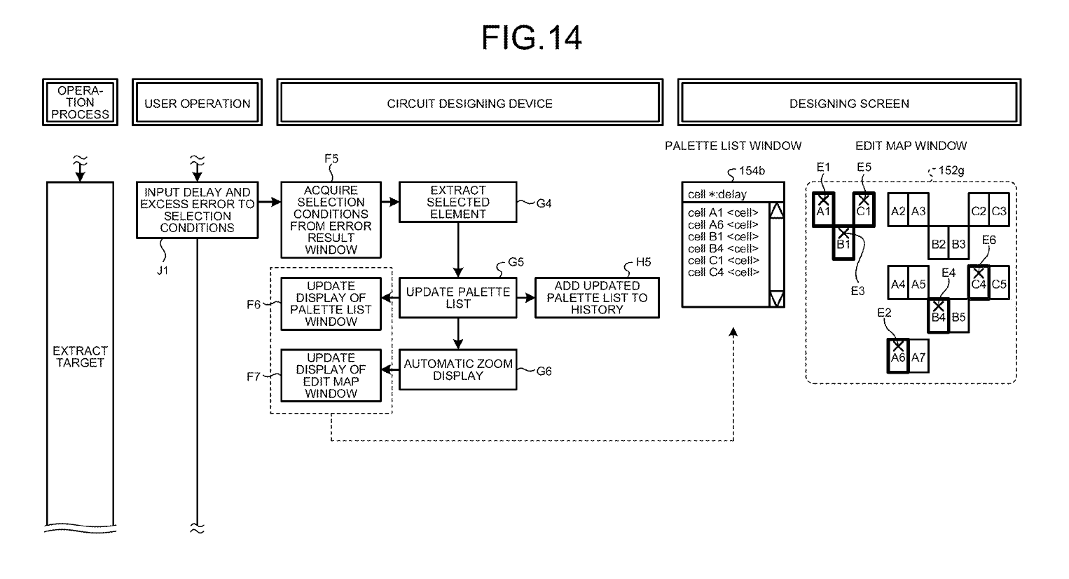

A phase to extract an element to be edited according to the present embodiment will now be described with reference to FIG. 14. FIG. 14 is an example diagram of a first process of the user operation, the operation of the circuit designing device, and the designing screen at a phase to extract an element to be edited according to the present embodiment. If the user inputs “excess delay error” as the selection conditions of the element (J1), for example, the circuit designing device 10 acquires the selection conditions from the error result window (F5) and extracts an element having the error to be modified (G4). The selecting unit 11 performs this extraction as illustrated in FIG. 14. This operation updates the palette list 134 (G5), and the update results are stored in the palette list 134 as the history information (H5). The update results of the palette list 134 update the display contents of the palette list window (F6). As a result, the palette list window lists only the cells A1, A6, B1, B4, C1, and C4 having an excess delay error as the elements to be edited as indicated by a palette list window 154b. Furthermore, “cell*:delay” is displayed on the top line of the palette list window 154b as the selection conditions described above. A colon “:” represents AND conditions in the present embodiment. Thus, “cell*:delay” means that the list of the elements displayed on the palette list window 154b is a result of selection made under two conditions of “an arbitrary cell” and “an element having an excess delay error”.

After the palette list 134 is updated, the circuit designing device 10 causes the display controller 14 to perform automatic zoom display (G6). Because the user selects no command or no element at this point, the execution status of the command and the selected element still remain the initial value. The selected element, however, is narrowed down under the two conditions described above. Thus, the selected element corresponds to the six elements of the cells A1, A6, B1, B4, C1, and C4. The edit map window automatically zooms in these cells on the palette list window 154b. As a result, the screen state of the edit map window 152f illustrated in FIG. 13 shifts to that of an edit map window 152g illustrated in FIG. 14. Furthermore, display of the six cells in which the error is detected is updated on the edit map window (F7) such that the respective cells are marked with a cross so as to enable the user to visually find the elements to be edited, for example. In FIG. 14, the cells A1, A6, B1, B4, C1, and C4 in the edit map window 152g thus updated have reference numerals E1 to E6 indicating the error result, respectively. This enables the user to promptly grasp the position of the elements having the error to be modified.

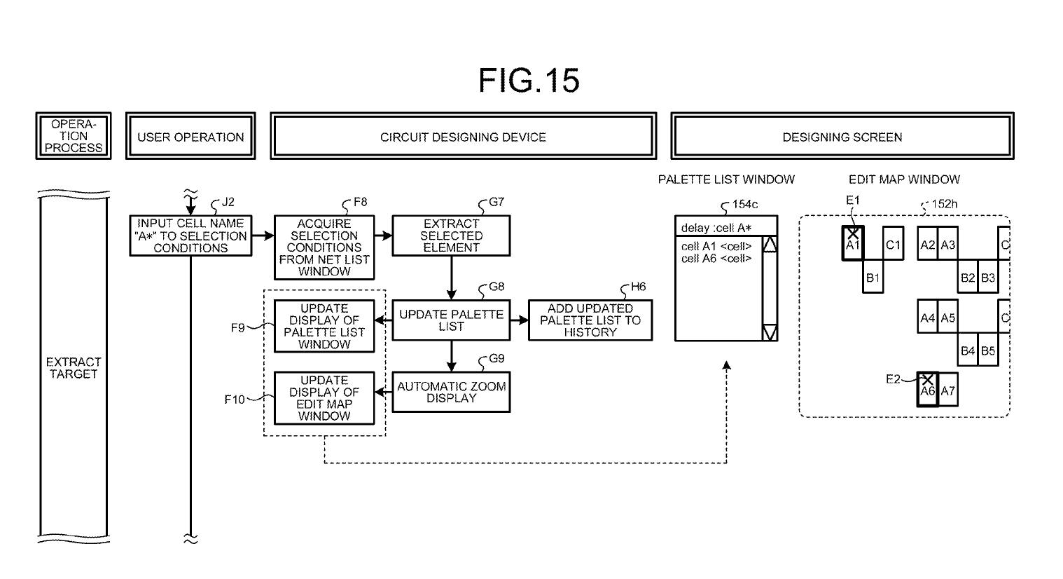

The process for narrowing down the elements from the error result window has been described above. The following describes a process for narrowing down the elements from the net list window with reference to FIG. 15. FIG. 15 is an example diagram of a second process of the user operation, the operation of the circuit designing device, and the designing screen at the phase to extract the element to be edited according to the present embodiment. As illustrated in FIG. 15, if the user further inputs a cell name “A*” as the selection conditions of the element (J2), for example, the circuit designing device 10 acquires the selection conditions from the net list window (F8) and extracts an element that meets the conditions (G7). The selecting unit 11 performs the extraction. This operation updates the palette list 134 (G8), and the update results are stored in the palette list 134 as the history information (H6). The update results of the palette list 134 update the display contents of the palette list window (F9). As a result, the palette list window displays the cells A1 and A6 alone as the elements to be edited as indicated by a palette list window 154c. Furthermore, text data of “delay:cell A*” is displayed on the top line of the palette list window 154c as the selection conditions described above. The text data of “delay:cell A*” means that the list of the elements displayed on the palette list window 154c is a result of selection made under two conditions of “an element having an excess delay error” and “a cell of cells A”.

After the palette list 134 is updated, the circuit designing device 10 performs automatic zoom display (G9). Because no command or no element is selected yet at this point, the execution status of the command and the selected element still remain the initial value. The selected element, however, is narrowed down under the two conditions described above. Thus, the selected element corresponds to the two elements of the cells A1 and A6. The edit map window automatically zooms in these cells on the palette list window 154c. As a result, the screen state of the edit map window 152g illustrated in FIG. 14 shifts to that of an edit map window 152h illustrated in FIG. 15. The cells A1 and A6 are displayed on the edit map window as the selection candidates of the target to be edited in a manner marked with a cross indicating the error result in the respective frames thereof (F10). In FIG. 15, the cells A1 and A6 in the edit map window 152h thus updated have the reference numerals E1 and E2 indicating the error result, respectively. Because the other cells B1, B4, C1, and C4 do not satisfy the selection condition of the cell “A*”, they are excluded from the target for identification display with the error reference numeral. This enables the user to promptly identify the cells desired as the target to be edited from the edit map window.

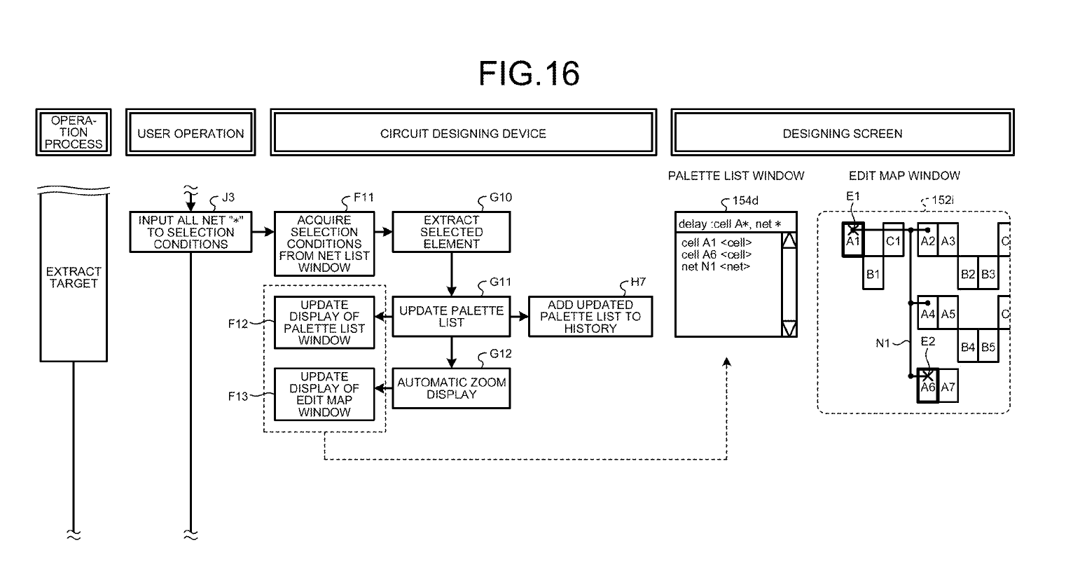

The process for narrowing down the elements from the net list window has been described above. The following describes a process for selecting a net as the target to be edited with reference to FIG. 16. FIG. 16 is an example diagram of a third process of the user operation, the operation of the circuit designing device, and the designing screen at the phase to extract the element to be edited according to the present embodiment. As illustrated in FIG. 16, if the user further inputs all the nets “*” as the selection condition of the element (J3) to check the error cause by displaying the wiring, for example, the circuit designing device 10 acquires the selection condition from the net list window (F11). Subsequently, the circuit designing device 10 extracts an element that meets the conditions (G10). The selecting unit 11 performs the extraction. This operation updates the palette list 134 (G11), and the update results are stored in the palette list 134 as the history information (H7). The update results of the palette list 134 update the display contents of the palette list window (F12). As a result, the palette list window displays a net N1 besides the cells A1 and A6 as the elements to be edited as indicated by a palette list window 154d. Furthermore, text data of “delay:cell A*, net*” is displayed on the top line of the palette list window 154d as the selection conditions described above. A comma “,” represents OR conditions in the present embodiment. The text data of “delay:cell A*, net*” means that the list of the elements displayed on the palette list window 154d is a result of selection made under two conditions of “an element having an excess delay error” and “a cell of cells A or all the nets”.

After the palette list 134 is updated, the circuit designing device 10 causes the display controller 14 to perform automatic zoom display (G12). Because no command or no element is selected yet at this point, the execution status of the command and the selected element still remain the initial value. The selected elements, however, are narrowed down under the two conditions described above. Thus, the selected element corresponds to the three elements of the cells A1 and A6 and the net N1. The edit map window automatically zooms in these elements on the palette list window 154d. As a result, the screen state of the edit map window 152h illustrated in FIG. 15 shifts to that of an edit map window 152i illustrated in FIG. 16. The cells A1 and A6 and the net N1 are displayed in an identifiable manner on the edit map window as the selection candidates of the target to be edited (F13). In FIG. 16, the edit map window 152i thus updated newly displays the net N1 that connects the cells A1, A2, A4, and A6 in addition to the cells A1 and A6 displayed previously. This can facilitate the user's check of the wiring state of the net to be edited and the positional relation between the net and the cells besides the arrangement of the cells.

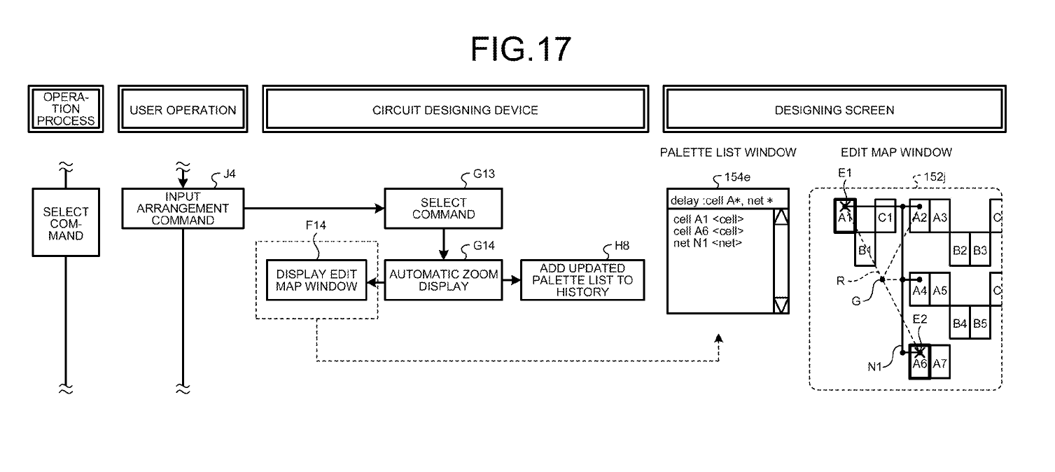

If the selection of the target to be edited is completed, a command is selected. The following describes a phase to select a command according to the present embodiment with reference to FIG. 17. FIG. 17 is an example diagram of the user operation, the operation of the circuit designing device, and the designing screen at a phase to select a command according to the present embodiment. As illustrated in FIG. 17, if the user inputs an arrangement command as a method for modifying the arrangement and wiring (J4), the circuit designing device 10 causes the selecting unit 11 to select the command of “arrangement of a cell” (G13). In association with the selection processing, zoom display is performed correspondingly to the case where the command is “arrangement of a cell” and the selected element is “plurality” (G14). Because the command is “arrangement of a cell” but the selected element remains in “plurality”, the central coordinates and the magnification for zoom display are the same as those of the previous phase. Thus, zoom display performed on an edit map window 152j maintains the state of the edit map window 152i illustrated in FIG. 16 (F14).

If the command is determined to be “arrangement of a cell”, a rubber band R for displaying the center of gravity is displayed for the cells A1, A2, A4, and A6 connected to the net N1 serving as a candidate of the target to be edited on a palette list window 154e. Because display of the rubber band R has been explained in the center-of-gravity-associated display processing, detailed explanation thereof will be omitted. As indicated in the edit map window 152j of FIG. 17, the rubber band R is formed in a manner extending radially from the coordinates of the center of gravity G of the four cells thus connected to the terminals of the respective cells.

While the palette list 134 is not updated at the phase to select a command in the present embodiment, the same palette list as that of the previous phase may be stored in the storage unit 13 as the history information of the present phase (H8).

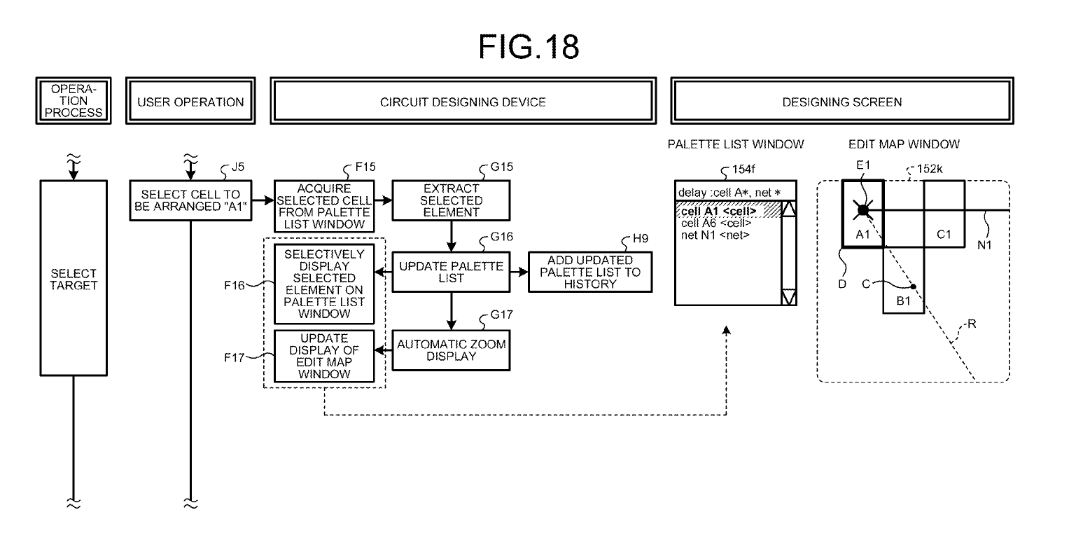

If the selection of the command is completed, the system control goes to a phase to select an element to be edited. FIG. 18 is an example diagram of the user operation, the operation of the circuit designing device 10, and the designing screen at a phase to select an element to be edited according to the present embodiment. As illustrated in FIG. 18, if the user selects the cell “A1” from the elements displayed in a palette list window 154f (J5), for example, the circuit designing device 10 causes the selecting unit 11 to acquire the selected cell from the palette list 134 (F15). This operation extracts the cell A1 as the element to be edited (G15). At the same time, the palette list 134 is updated (G16), and the update results are stored in the palette list 134 as the history information (H19). The update results of the palette list 134 update the display contents of the palette list window (F16). As a result, the palette list window highlights the cell A1 thus selected alone as the element to be edited as indicated by the palette list window 154f (a shaded portion in FIG. 18).

After the palette list 134 is updated, the circuit designing device 10 causes the display controller 14 to perform automatic zoom display (G17). Because the command of “arrangement of a cell” is selected at this point (J4 in FIG. 17) and the cell A1 is selected at J5, zoom display is performed centering on a lower-left end point D of the cell A1. Subsequently, the center-of-gravity-associated display processing causes the lower-left end point D of the cell A1 to be displayed in a manner deviating from the center of the screen such that the central coordinates C of an edit map window 152k is positioned on a line passing through the cell A1 and the coordinates of the center of gravity G (refer to FIG. 17) (F17). As a result, the screen state of the edit map window 152j illustrated in FIG. 17 shifts to that of the edit map window 152k illustrated in FIG. 18. As described above, the circuit designing device 10 uses selection of a cell to be edited as a trigger to automatically perform zoom processing in a manner facilitating wiring from the cell. This improves the work efficiency compared with the case where the user manually adjusts the zoom for him/herself.

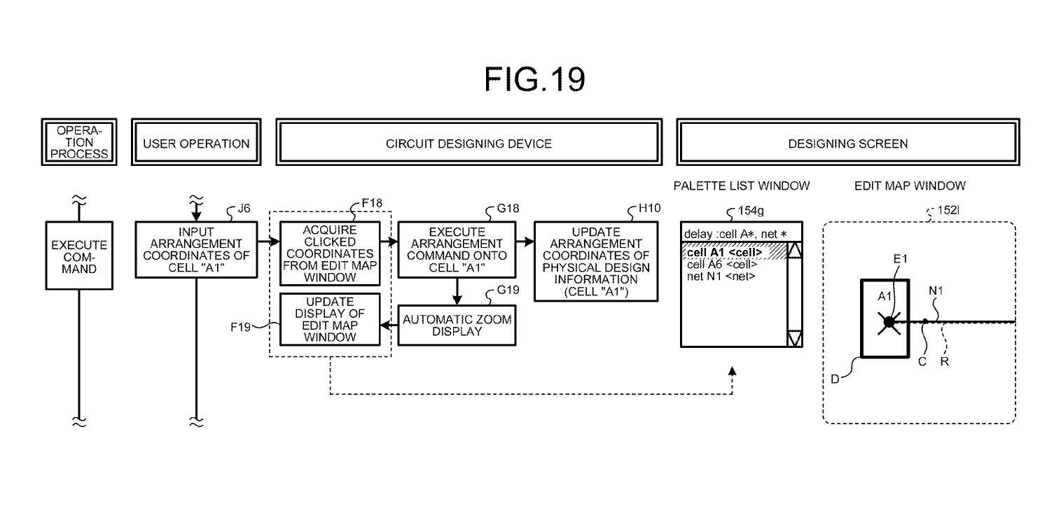

If the target to be arranged is determined to be the cell A1, the arrangement of the cell A1 is actually changed. The following describes the user operation, the operation of the circuit designing device 10, and the designing screen at a phase to execute a command with reference to FIG. 19. FIG. 19 is an example diagram of the user operation, the operation of the circuit designing device, and the designing screen at a phase to execute a command according to the present embodiment. As illustrated in FIG. 19, if new arrangement coordinates of the cell A1 is input (J6), the circuit designing device 10 acquires the coordinates from the edit map window (F18). The input operation is performed by dragging and dropping the mouse and rotating a wheel of a mouse with a wheel and clicking the mouse, for example. If an arrangement command for the cell A1 is executed based on the coordinates acquired at F18 (G18), the circuit designing device 10 updates the arrangement coordinates of the cell A1 in the physical design information 132 (H10) and performs automatic zoom display (G19). A palette list window 154g maintains the display state at the previous phase, whereas an edit map window 152l is updated in association with the movement of the cell A1 (F19). Specifically, because the cell A1 is moved to an appropriate position in a downward direction on the screen, the edit map window 152l is updated such that the center point C of the screen is positioned on a line passing through the position coordinates to which the cell A1 is moved and the coordinates of the center of gravity G (refer to FIG. 17). As a result, the rubber band R for displaying the center of gravity and the net N1 are displayed as a line passing through the center point C of the screen and ending at the error reference numeral E1 as illustrated in FIG. 19.

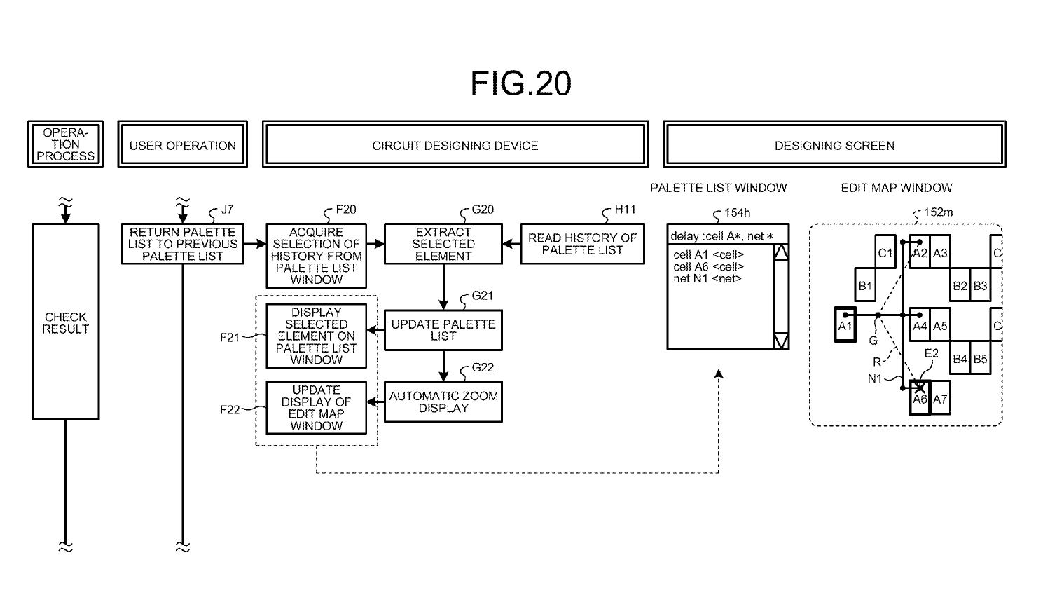

FIG. 20 is an example diagram of the user operation, the operation of the circuit designing device, and the designing screen at a phase to check edit results according to the present embodiment. At the subsequent phase to check the results, the user returns the palette list 134 to the previous palette list 134 to check the edit results (J7 in FIG. 20). If the history information is selected by a palette list window 154h (F20), the circuit designing device 10 extracts the selected element (G20) based on the history information read from the palette list 134 (H11). This operation updates the palette list 134 with data in which the cells A1 and A6 and the net N1 are selected (G21). The update results are listed on the palette list window 154h (F21). As a result, the state of the palette list window 154h shifts to that of the palette list window 154e of FIG. 17 as illustrated in FIG. 20. In addition, the circuit designing device 10 causes the display controller 14 to perform zoom display on the three elements described above (a plurality of elements) (G22). As a result, an edit map window 152m (refer to FIG. 20) is updated with display contents reflecting the change in the arrangement of the cell A1 (F22).

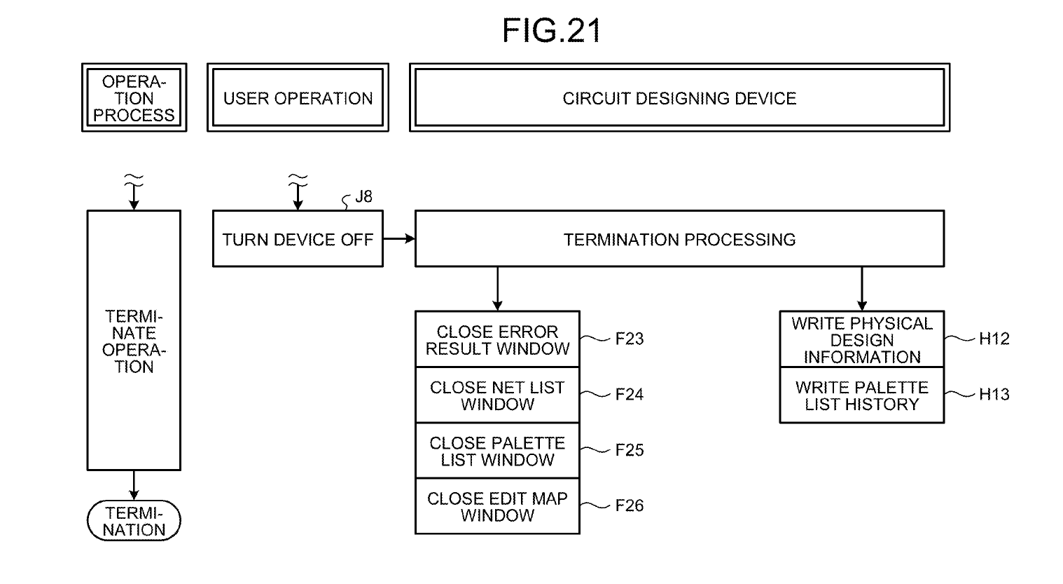

FIG. 21 is an example diagram of the user operation, the operation of the circuit designing device 10, and the designing screen at a phase to terminate the edit operation according to the present embodiment. As illustrated in FIG. 21, if the user inputs a termination instruction of the circuit designing device 10 to terminate the arrangement and wiring operation (J8), the results of the arrangement and wiring operation are stored in the physical design information 132 (H12) and are stored in the palette list 134 as history (H13) as well. The circuit designing device 10 then closes the four windows (F23 to F26) to terminate the series of arrangement and wiring edit processing.

As described above, the circuit designing device 10 according to the present embodiment includes the display unit 15, the selecting unit 11, the calculating unit 12, and the display controller 14. The display unit 15 displays the designing screen. The selecting unit 11 selects an element to be edited from elements displayed on the designing screen. The calculating unit 12 calculates the central coordinates and the magnification for zoom display of the designing screen based on the execution status of a command when the element is selected by the selecting unit 11. The display controller 14 causes the display unit 15 to perform zoom display of the designing screen at the magnification thus calculated centering on the central coordinates thus calculated. Specifically, if an element is selected from the palette list 134, the display controller 14 performs zoom display so as to provide a designing screen suitable for the arrangement and wiring operation of the element thus selected. The selection of the element causes the edit map window to automatically switch from the window for selection of a target to be edited to the window for arrangement and wiring. Thus, the user can perform the arrangement and wiring operation on the designing screen suitable for edit of a desired element without performing a zoom operation for him/herself. This improves the work efficiency in the arrangement and wiring of the element.

The circuit designing device 10 according to the present embodiment includes the selecting unit 11 and the display controller 14. The selecting unit 11 selects an element based on particular selection conditions. The display controller 14 causes the display unit 15 to display the element selected by the selecting unit 11 as a candidate of the target to be edited. Specifically, the circuit designing device 10 causes the selecting unit 11 to select an element based on the logical design information 131, the physical design information 132, and the constraint check result information (error information) 133 and displays the element on the palate list window occasionally. This enables the user to narrow down the elements serving as candidates of the target to be edited simply by inputting various types of information described above as the selection conditions without directly selecting the elements on which an arrangement and wiring operation is to be performed for him/herself. The results obtained by narrowing down the elements are displayed on the palette list window and the edit map window as the candidates of the element to be edited in real time. Referring to these windows enables the user to readily and promptly specify the desired element to be the target for the arrangement and wiring operation from the palette list 134.

In the circuit designing device 10 according to the present embodiment, the elements include a cell and a net. The calculating unit 12 calculates the central coordinates and the magnification for zoom display of the designing screen based on whether the element selected by the selecting unit 11 corresponds to a cell or a net. Specifically, to change the way of zoom display performed by the display controller 14 depending on the command executed when the target is selected, the circuit designing device 10 performs zoom display corresponding to the command specified by the user on the edit map window. Thus, the circuit designing device 10 can provide a designing screen that improves the work efficiency to the user correspondingly to the type of an operation desired by the user. In other words, the circuit designing device 10 can respond flexibly to contents of work performed by the user.

The circuit designing device 10 according to the present embodiment includes the selecting unit 11 and the calculating unit 12. The selecting unit 11 selects a plurality of elements as the element to be edited. If the selecting unit 11 selects a plurality of elements, the calculating unit 12 calculates the central coordinates of a rectangle that includes the elements and at least one side of which is circumscribed about any of the elements included as the central coordinates. Furthermore, the calculating unit 12 calculates the magnification that causes a side of the rectangle to account for a particular ratio of a side of a display area on the display unit 15 as the magnification. In other words, if the selecting unit 11 selects a plurality of elements, the circuit designing device 10 performs processing different from that performed in the case where one element is selected, that is, processing for displaying a rectangle circumscribed about the elements in an enlarged manner on the edit map window. This can provide a panoramic view of all the elements to be edited to the user. As a result, the work efficiency in the arrangement and wiring is improved.

The circuit designing device 10 according to the present embodiment includes the display unit 15 and the display controller 14. The display unit 15 displays a plurality of elements and the center of gravity among the elements on the designing screen. The display controller 14 performs zoom display of the designing screen. In addition, the display controller 14 causes the display unit 15 to display the designing screen such that the central coordinates of the designing screen are positioned on a line passing through a cursor indicating an input position on the designing screen zoom-displayed and the center of gravity. In other words, the circuit designing device 10 causes the display controller 14 to perform zoom display such that the central coordinates of the zoom is positioned on the line connecting the mouse cursor and the center of gravity regardless of the position of the mouse cursor on the edit map window. To equalize wiring delay, equal-length wiring whose wiring distances among the cells are equal to one another is preferably employed as wiring among a plurality of cells. The circuit designing device 10 according to the present embodiment facilitates the user's wiring in a direction toward the center of gravity of the cells on the designing screen. This enables the user to perform equal-length wiring readily and promptly. As a result, the work efficiency in the wiring operation is improved.

In the circuit designing device 10 according to the present embodiment, the particular selection conditions are conditions based on information selected from first, second, and third information described below. The first information indicates whether the element to be edited corresponds to a cell or a net. The second information indicates how the element is arranged or wired on the designing screen. The third information is information related to an error in the arrangement or the wiring of the element. Among others, zoom display may possibly cause cells other than the cell to be edited to move outside of the window, thereby making it difficult to see these cells. The user, however, can perform the wiring operation constantly near the center of the screen while using the rubber band for displaying the center of gravity as a guide in the wiring direction and using the distance between the mouse cursor and the center of the screen as a guide of the distance between the center of the screen and the position of the center of gravity. This facilitates the wiring operation in a direction desired by the user, thereby resolving the concern described above.

Circuit Designing Program

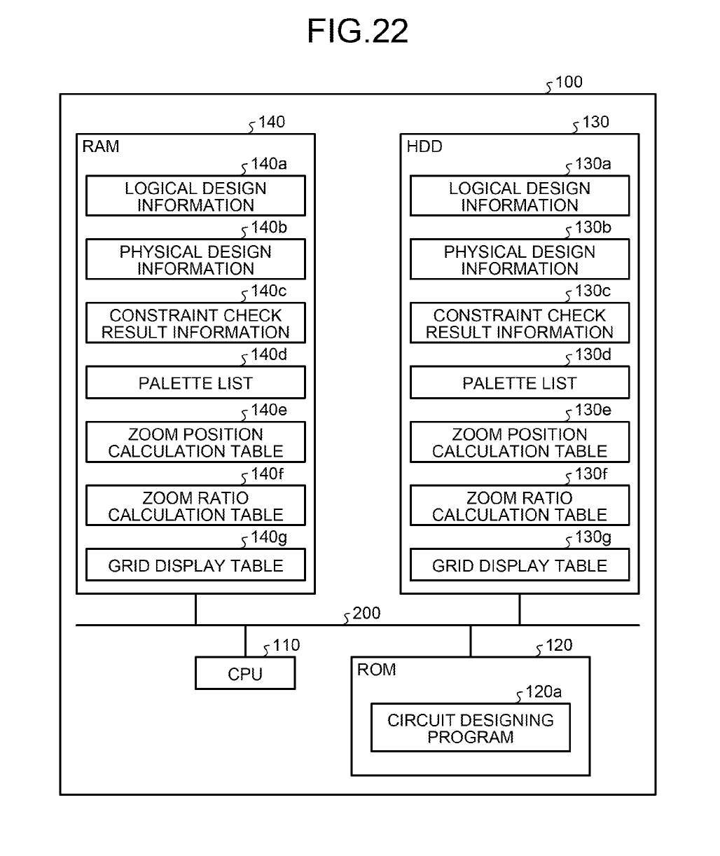

The various types of processing of the circuit designing device 10 described in the embodiment above may be carried out by a computer system, such as a personal computer and a workstation, executing a computer program prepared in advance. The following describes an example of a computer that executes a circuit designing program having functions similar to those of the circuit designing device 10 described in the embodiment above with reference to FIG. 22. FIG. 22 is a diagram of a computer that executes the circuit designing program.

As illustrated in FIG. 22, a computer 100 according to the present embodiment includes a central processing unit (CPU) 110, a read only memory (ROM) 120, a hard disk drive (HDD) 130, and a random access memory (RAM) 140. These components 100 to 140 are connected to one another via a bus 200.

The ROM 120 stores therein in advance a circuit designing program that provides functions similar to those of the selecting unit 11, the calculating unit 12, the display controller 14, and the display unit 15 described in the embodiment above. In other words, the ROM 120 stores therein a circuit designing program 120a as illustrated in FIG. 22. The circuit designing program 120a may be separated as needed.

The CPU 110 reads and executes the circuit designing program 120a from the ROM 120.

The HDD 130 stores therein logical design information 130a, physical design information 130b, constraint check result information 130c, and a palette list 130d. The HDD 130 further stores therein a zoom position calculation table 130e, a zoom ratio calculation table 130f, and a grid display table 130g. The logical design information 130a, the physical design information 130b, and the constraint check result information 130c correspond to the logical design information 131, the physical design information 132, and the constraint check result information 133 illustrated in FIG. 1, respectively. The palette list 130d corresponds to the palette list 134 illustrated in FIG. 1. The zoom position calculation table 130e, the zoom ratio calculation table 130f, and the grid display table 130g correspond to the zoom position calculation table 135, the zoom ratio calculation table 136, and the grid display table 137 illustrated in FIG. 1, respectively.

The CPU 110 reads the logical design information 130a, the physical design information 130b, the constraint check result information 130c, the palette list 130d, the zoom position calculation table 130e, the zoom ratio calculation table 130f, and the grid display table 130g. The CPU 110 then stores these pieces of data in the RAM 140. The CPU 110 uses logical design information 140a, physical design information 140b, constraint check result information 140c, and a palette list 140d stored in the RAM 140 to execute the circuit designing program 120a. Furthermore, the CPU 110 uses a zoom position calculation table 140e, a zoom ratio calculation table 140f, and a grid display table 140g stored in the RAM 140 to execute the circuit designing program 120a. In terms of the pieces of data stored in the RAM 140, all the pieces of data do not have to be stored in the RAM 140, and data requested for processing alone may be temporarily stored in the RAM 140.

The circuit designing program 120a does not have to be stored in the HDD 130 in advance.

The computer 100, for example, may store the program in a “portable physical medium”, such as a flexible disk (FD), a compact disk read-only memory (CD-ROM), a digital versatile disk (DVD), an magneto-optical disk, and an integrated circuit (IC) card, inserted into the computer 100. The computer 100 may read and execute the program from these media.

Furthermore, the program may be stored in a “second computer (or server)” connected to the computer 100 via a public line, the Internet, a local area network (LAN), and a wide area network (WAN), for example. The computer 100 may read and execute the program from the second computer or server.

An aspect of a designing device disclosed in the present application can improve the efficiency of an arrangement and wiring operation in designing a circuit, for example.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A designing device comprising:
a memory; and
a processor coupled to the memory, wherein the processor executes a process comprising:
displaying a designing screen;
selecting an element serving as a target to be edited from elements displayed on the designing screen;
calculating a central coordinate and magnification for zoom display of the designing screen based on an execution status of a command when the element is selected at the selecting; and
causing a display to perform zoom display of the designing screen at the magnification calculated centering on the central coordinate calculated.

2. The designing device according to claim 1, wherein
the selecting includes selecting the element based on predetermined selection conditions, and
the causing includes causing the display to display the element selected at the selecting as a candidate of the target to be edited.

3. The designing device according to claim 1, wherein
the element includes a cell and a net, and
the calculating includes calculating the central coordinate and the magnification for zoom display of the designing screen based on whether the element selected at the selecting corresponds to the cell or the net.

4. The designing device according to claim 1, wherein
the selecting includes selecting a plurality of elements as the element serving as the target to be edited, and
the calculating includes calculating, when the plurality of elements are selected, the central coordinate of a rectangle that includes the plurality of elements and at least one side of which is circumscribed about any of the elements included as the central coordinate and calculating magnification that causes a side of the rectangle to account for a predetermined ratio of a side of a display area on the display as the magnification.

5. The designing device according to claim 2, wherein the predetermined selection conditions are conditions based on information selected from first information indicating whether the element serving as the target to be edited corresponds to a cell or a net, second information indicating how the element is arranged or wired on the designing screen, and third information related to an error in arrangement or wiring of the element.

6. The designing device according to claim 1, wherein
the displaying includes displaying a plurality of elements and the center of gravity among the plurality of elements on the designing screen, and
the causing includes performing zoom display of the designing screen and causing the display to display the designing screen such that the central coordinate of the designing screen are positioned on a line passing through a cursor indicating an input position on the designing screen zoom-displayed and the center of gravity.

7. A designing method comprising:
calculating, using a processor, a central coordinate and magnification for zoom display of a designing screen based on an execution status of a command when an element serving as a target to be edited is selected from elements displayed on the designing screen;
performing, using the processor, zoom display of the designing screen at the magnification calculated centering on the central coordinate calculated; and
displaying, using the processor, the designing screen at the magnification centering on the central coordinate.

8. A computer-readable recording medium having stored therein a program that causes a computer to execute a designing process comprising:
calculating a central coordinate and magnification for zoom display of a designing screen based on an execution status of a command when an element serving as a target to be edited is selected from elements displayed on the designing screen;
performing zoom display of the designing screen at the magnification calculated centering on the central coordinate calculated; and
displaying the designing screen at the magnification centering on the central coordinate.
